(19) United States
(12) Patent Application Publication
(10) Pub. No.: US 2019/0111368 A1
(43) Pub. Date: Apr. 18, 2019

(54) Utilization of Cannabis, Industrial Hemp or Cannabinoids as Filtration Medium

(71) Applicant: Michael Daniel Crippen, Tampa, FL (US)

(72) Inventor: Michael Daniel Crippen, Tampa, FL (US)

(21) Appl. No.: 15/786,601

(22) Filed: Oct. 18, 2017

(51) Int. Cl. B01D 39/18; B01D 39/16; C02F 1/00; B01D 46/00

(52) U.S. Cl. CPC B01D 39/18; B01D 39/1615; C02F 1/001; B01D 2239/0442; B01D 46/0028; C02F 2303/04; B01D 46/0001

(57) ABSTRACT

The invention provides improved filtration materials and mediums accommodating to various filter types and designs. Materials/mediums include both “raw” cannabis (cannabinoids) as filter components such as but not limited to fibers, as well as altered materials (compounds) such as but not limited to sponges. These materials/mediums can be fashioned into any form, shape, density or design such as but not limited to inserts for faucet attachments, mechanical oil filters, or home AC filters. A primary feature of cannabis in use as filtration material is the anti-bacterial/-microbial properties. Trace cannabinoids found in all cannabis remain chemically active through material processing, providing a surficial efficacy as high as 99% with regard to sanitizing effects. Specifically as liquids, gases or solids come in contact with these materials/mediums they will be “sanitized” while the materials/mediums also capture particulates, compared to UV or chlorine treatment—neither of which removes particulates.

The invention provides improved filtration materials and mediums, accommodating to various filter types, formats and designs.

### FIELD AND SCOPE OF INVENTION

This invention covers utilization of cannabis and/or cannabinoids in the function of a filtration material and/or substance treatment based on this range of classifications:

C02F 1/00—Treatment of water, waste water, or sewage (C02F 3/00-C02F 9/00 take precedence)

C02F 1/001—Processes for the treatment of water whereby the filtration technique is of importance (C02F 1/44 takes precedence; construction of filters in general B01D 24/00-B01D 41/00)}

C02F 1/002—Using small portable filters for producing potable water, e.g. personal travel or emergency equipment, survival kits, combat gear (C02F 1/003 takes precedence)

C02F 1/003—Using household-type filters for producing potable water, e.g. pitchers, bottles, faucet mounted devices (C02F 9/005 takes precedence)}

C02F 1/004—Using large scale industrial sized filters

AO1K 63/04—Aquarium filters

A24D 3/00—Filters for cigars and cigarettes

A47J 31/06—Filters for coffee or tea-making machines

A47J 37/12—filters for frying fat

A47L 9/10—filters for suction cleaners

A61M 5/165—Blood or infusion liquid filters

B01D 12/00, B01D 17/00, B01D 43/00—Liquid-liquid separation, e.g. for filtering elements made hydrophilic or hydrophobic

B01D 39/00—Filtering material and its regeneration, as well as filtering aids

B01D 46/00—Gas or air filters in general

B01L—Filtration devices for laboratory use

B03B 5/48—“Dewatering” ore or coal slurry

B03C 1/00—Magnetic filters

B07B 1/00—Screens or sieves per se

B23Q 11/10—Filters for lubricating and cooling systems in turning, boring or milling machines

B24B 55/00—Filters for cooling systems in grinding machines

B29C 47/68—Extrusion filters

B30B 9/02—Filter presses

C02F—Purification of process water, drinking water and waste water

C12H 1/00—Filters for alcoholic beverages

D01D 1/10—Filtering spinning solution or melt

D06F 39/10—Filters for washing machines

D21D—Filters or strainers for papermaking

E03B 3/18, E03B 7/07—Filters in water collecting systems

E21B 43/02—Subsoil filters for boreholes

F02M 35/02—Air filters for internal-combustion engines

F04B 39/16, F04D 29/70—Filters for pumps

F16L 55/24—Filters in pipe systems

F16N 39/06—Filtration of lubricants

G01F 15/12—Filters for volume measuring apparatus

B01D 23/00—Gravity filters (with moving filtering elements B01D 33/0035)

B01D 23/005—Making filtering elements, not provided for elsewhere (see also B01D 25/001, B01D 27/005, B01D 29/0093)

B01D 23/02—With fixed filter bodies

B01D 23/04—With filter bags filtering from the inside

B01D 23/06—With rigid tubular bodies

B01D 23/08—With saucer-shaped filtering elements

B01D 23/10—With loose filter material

B01D 23/12—With filtering material supported on louvred sides

B01D 23/14—Carbon filters

B01D 23/16—Sand or gravel filters (filterbed-basin filters, small bed filters, e.g. in closed housing B01D 23/10)

B01D 23/18—Bottoms of filter beds

B01D 23/20—Feed or discharge devices (nozzles B05B)

B01D 23/205—Special adaptation of spray heads therefor

B01D 23/24—Regeneration of the filter material in the filter

B01D 23/26—Integrally combined with devices for controlling the filtration (shutting-off elements, changing over from one element to another B01D 35/12, B01D 35/14; control of filtration processes B01D 37/04)

B01D 23/28—Filter funnels; Holders therefor (funnels in general B67C; funnels for laboratory use B01L; coffee or tea strainers or apparatus A47J 31/00- A47J 31/06)

B01D 24/00—Filters comprising loose filtering material, i.e. filtering material without any binder between the individual particles or fibres thereof (B01D 27/02 takes precedence)

B01D 24/001—Making filter elements (not provided for elsewhere) (see also B01D 25/001, B01D 27/005, B01D 29/012, B01D 29/111, B01D 33/0093)

B01D 24/002—With multiple filtering elements in parallel connection}

B01D 24/004—Arranged concentrically or coaxially}

B01D 24/005—Filters being divided into a plurality of cells or compartments (B01D 24/004 takes precedence)

B01D 24/007—With multiple filtering elements in series connection

B01D 24/008—Arranged concentrically or coaxially

B01D 24/02—With the filter bed stationary during the filtration

B01D 24/04—The filtering material being clamped between pervious fixed walls (B01D 24/10, B01D 24/20 take precedence)

B01D 24/042—The filtering material being held in a flexible porous bag}

B01D 24/045—With at least one flat vertical wall}

B01D 24/047—With vertical tubes distributing the liquid to be filtered or for collecting filtrate

B01D 24/06—The pervious walls comprising a series of louvres or slots

B01D 24/08—The filtering material being supported by at least two pervious coaxial walls

B01D 24/10—The filtering material being held in a closed container

B01D 24/105—Downward filtration without specifications about the filter material supporting means

B01D 24/12—Downward filtration, the filtering material being supported by pervious surfaces (B01D 24/18 takes precedence)

B01D 2024/125—Spray heads specially adapted therefor

B01D 24/14—Downward filtration, the container having distribution or collection headers or pervious conduits (B01D 24/18 takes precedence)

B01D 2024/145—Spray heads specially adapted therefor

B01D 24/16—Upward filtration (B01D 24/18 takes precedence)

B01D 2024/162—Spray heads specially adapted therefor

B01D 24/165—The filtering material being supported by pervious surfaces

B01D 24/167—The container having distribution or collection headers or pervious conduits

B01D 24/18—Combined upward and downward filtration

B01D 24/183—The filtering material being supported by pervious surfaces

B01D 24/186—The container having distribution or collection headers or pervious conduits

B01D 24/20—The filtering material being provided in an open container

B01D 24/205—Downward filtration without specifications about the filter material supporting means

B01D 24/22—Downward filtration, the filter material being supported by pervious surfaces

B01D 24/24—Downward filtration, the container having distribution or collection headers or pervious conduits

B01D 24/26—Upward filtration

B01D 24/263—The filtering material being supported by pervious surfaces}

B01D 24/266—The container having distribution or collection headers or pervious conduits}

B01D 24/28—With the filter bed moving during the filtration (with the filter bed fluidised B01D 24/36)

B01D 24/30—Translation

B01D 24/305—Vibrations

B01D 24/32—Rotation

B01D 24/34—With the filtering material and its pervious support moving (tipping buckets, trays or like sections B01D 33/327)

B01D 24/36—With the filter bed fluidised during the filtration (with the filter bed being stationary B01D 24/02)

B01D 24/38—Feed or discharge devices

B01D 24/383—Using multiple way valves

B01D 24/386—Internal recirculation

B01D 24/40—For feeding

B01D 24/402—Containing fixed liquid displacement elements or cores

B01D 24/405—Special treatment of the feed stream before contacting the filtering material, e.g. cutting (B01D 35/24, B01D 37/02, B01D 37/03 take precedence)

B01D 24/407—Provoking a tangential stream

B01D 24/42—For discharging filtrate

B01D 24/425—Containing fixed liquid displacement elements or cores

B01D 24/44—For discharging filter cake, e.g. chutes

B01D 24/46—Regenerating the filtering material in the filter (B01D 24/44 takes precedence)

B01D 24/4605—By scrapers, brushes, nozzles or the like placed on the cake-side of the stationary filtering material and only contacting the external layer (B01D 24/4631 takes precedence)

B01D 24/461—By scrapers

B01D 24/4615—By brushes

B01D 24/4621—By nozzles acting on the cake side of the filter material, or by fluids acting in co-current direction with the feed stream

B01D 24/4626—Construction of spray heads specially adapted for regeneration of the filter material or for filtrate discharging

B01D 24/4631—Counter-current flushing, e.g. by air

B01D 24/4636—With backwash shoes; with nozzles

B01D 24/4642—With valves, e.g. rotating valves

B01D 24/4647—With a rectilinear movement of the closing means

B01D 24/4652—By using gasbumps

B01D 24/4657—By using membranes

B01D 24/4663—By using pistons

B01D 24/4668—By moving the filtering element (B01D 24/4605 and B01D 24/4631 take precedence)

B01D 24/4673—Using rotary devices or vibration mechanisms, e.g. stirrers

B01D 24/4678—Using free vortex flow

B01D 24/4684—Using spray devices

B01D 24/4689—Displacement of the filtering material to a compartment of the filtering device for regeneration

B01D 24/4694—Containing filter material retaining means (e.g. screens, balls) placed on the surface of the filter material

B01D 24/48—Integrally combined with devices for controlling the filtration

B01D 24/4807—Handling the filter cake for purposes other than regenerating

B01D 24/4815—For washing

B01D 24/4823—For drying

B01D 24/483—By compression

B01D 24/4838—By gases or by heating

B01D 24/4846—Retarding cake deposition on the filter during the filtration period, e.g. using stirrers (B01D 24/407 takes precedence)

B01D 24/4853—By clearness or turbidity measuring

B01D 24/4861—By flow measuring

B01D 24/4869—By level measuring

B01D 24/4876—In which the filtering elements are moved between filtering operations; particular measures for removing or replacing the filtering elements (B01D 24/46, B01D 24/4807 take precedence)

B01D 24/4884—By pressure measuring

B01D 24/4892—By temperature measuring

B01D 27/00—Cartridge filters of the throw-away type

B01D 27/005—Making filter elements (not provided for elsewhere) (see also B01D 24/001, B01D 25/001, B01D 29/012, B01D 29/111, B01D 33/0093)

B01D 27/02—With cartridges made from a mass of loose {granular or fibrous} material

B01D 27/04—With cartridges made of a piece of unitary material, e.g. filter paper

B01D 27/06—With corrugated, folded or wound material

B01D 27/07—Having a coaxial stream through the filtering element

B01D 27/08—Construction of the casing

B01D 27/10—Safety devices, e.g. by-passes

B01D 27/101—Filter condition indicators

B01D 27/103—Bypass or safety valves

B01D 27/105—Bidirectional working filters

B01D 27/106—Anti-leakage or anti-return valves

B01D 27/108—Flow control valves; Damping or calibrated passages

B01D 27/14—Having more than one filtering element

B01D 27/142—Connected in parallel

B01D 27/144—Arranged concentrically or coaxially

B01D 27/146—Connected in series

B01D 27/148—Arranged concentrically or coaxially

B01D 29/00—Other filters with filtering elements stationary during filtration, e.g. pressure or suction filters, or filtering elements therefor {(B01D 24/00, B01D 25/00 and B01D 27/00 take precedence)

B01D 29/0002—Aspects of other filters with filtering elements stationary during filtration, or of filtering elements thereof

B01D 29/0004—Filters with flat filtering elements

B01D 29/0006—Making filtering elements

B01D 29/0009—With curved filtering elements

B01D 29/0011—Ring shaped

B01D 29/0013—Filters in which the filtering elements are moved between filtering operations; Means specially adapted for removing the filtering elements or introducing new ones; Transport systems specially adapted for the filtering elements

B01D 29/0015—Filtering bands

B01D 29/0018—Filters with screens or sheets, e.g. cloth, paper

B01D 29/002—With rigid, self-supporting filtering elements, e.g. of ceramic material

B01D 29/0022—Filters with corrugated, folded, or wound sheets

B01D 29/0025—Allowing a coaxial stream through the filtering element (for cartridge filters B01D 27/06)

B01D 29/0027 . . . {Filters with loose, granular, or fibrous filtering material}

B01D 29/0029 . . . {Bag, cage, hose, tube, sleeve, or like filters}

B01D 29/0031—Pressing-out operation after filtration, e.g. by means of membranes (filter presses per se B01D 25/12)

B01D 29/0034—Filters having flexible filtering material

B01D 29/0036—Which is supported

B01D 29/0038—On solid frames with surface grooves and the like

B01D 29/004—To take up a concertina shape during filtration

B01D 29/0043—Having rigid self-supporting filtering material (B01D 29/0068 takes precedence)

B01D 29/0045—Edge filtering elements

B01D 29/0047—With multiple filtering units

B01D 29/005—Connected in parallel (B01D 29/0056 takes precedence)

B01D 29/0052—Connected in series (B01D 29/0059 takes precedence)

B01D 29/0054—Arranged concentrically or coaxially

B01D 29/0056—Connected in parallel

B01D 29/0059—Connected in series

B01D 29/0061—Which are vibrated

B01D 29/0063—Which are open-ended

B01D 29/0065—Filter candles

B01D 29/0068—Filters with hollow discs side-by-side on or around one or more tubes (with elements moving during filtration B01D 33/0048, B01D 33/0051)

B01D 29/007—Having filtrate discharge tubes fixed non-perpendicularly to the filtering surfaces

B01D 29/0072—Filters integrally combined with devices for controlling the filtration (for shutting-off elements or changing over from one element to another B01D 35/12, B01D 35/14; controlling filtration processes B01D 37/04)

B01D 29/0075—Regeneration of the filtering material in the filter (for two separate filter elements placed in different units B01D 35/12)

B01D 29/0077—By scrapers, brushes, nozzles or the like placed on the cake-side of the filters (B01D 29/0084 takes precedence)

B01D 29/0079—Counter-current flushing, e.g. by air bumps

B01D 29/0081—With backwash shoes; with nozzles

B01D 29/0084—By moving the filter element (B01D 29/0088 takes precedence)

B01D 29/0086—By vibration

B01D 29/0088—By centrifugal force

B01D 29/009—Filters having feed or discharge devices

B01D 29/0093—Making filtering elements (not provided for elsewhere) (see also B01D 23/005, B01D 25/001, B01D 27/005)

B01D 29/0095—Flat filtering elements (B01D 25/12, B01D 25/26, B01D 29/0015, B01D 29/0068 take precedence)

B01D 29/0097—Curved filtering elements, e.g. concave filtering elements

B01D 29/01—With flat filtering elements (B01D 29/39 takes precedence)

B01D 29/012—Making filtering elements (making bag, cage, hose, tube, sleeve or like filtering elements B01D 29/111)

B01D 29/014—With curved filtering elements (construction B01D 29/035, B01D 29/071)

B01D 29/016—With corrugated, folded or wound filtering elements

B01D 29/018—Ring shaped

B01D 29/03—Self-supporting

B01D 29/031—With corrugated, folded filtering elements

B01D 2029/033—Bar screens

B01D 29/035—With curved filtering elements

B01D 29/036—Ring shaped

B01D 29/038—With corrugated, folded filtering elements

B01D 29/05—Supported

B01D 29/055—Ring shaped

B01D 29/07—With corrugated, folded or wound filtering sheets

B01D 29/071—With curved filtering elements (B01D 29/072, B01D 29/073 take precedence)

B01D 29/072—Ring shaped

B01D 29/073—With wound filtering sheets

B01D 2029/075—Located in a closed housing and comprising scrapers or agitators on the cake side of the filtering elements, e.g. Nutsche- or Rosenmund-type filters for performing multiple step operations

B01D 29/085—Funnel filters; Holders therefor

B01D 29/09—With filtering bands, e.g. movable between filtering operations (B01D 25/121 takes precedence)

B01D 29/093—Combined with means to fasten the opposite edges of the filtering band together, e.g. Zipper

B01D 29/096—Construction of filtering bands or supporting belts, e.g. devices for centering, mounting or sealing the filtering bands or the supporting belts

B01D 29/11—With bag, cage, hose, tube, sleeve or like filtering elements

B01D 29/111—Making filtering elements

B01D 29/112—Ring shaped filters wherein both opposite axial sides are opened and the axial length is shorter than the diameter, e.g. as used in hydraulic transmission systems

B01D 29/114—Arranged for inward flow filtration (B01D 29/15, B01D 29/33 take precedence)

B01D 29/115—Open-ended, the arrival of the mixture to be filtered and the discharge of the concentrated mixture are situated on both opposite sides of the filtering element

B01D 29/117—Arranged for outward flow filtration (B01D 29/23, B01D 29/35 take precedence)

B01D 29/118—Open-ended

B01D 29/13—Supported filter elements

B01D 29/15—Arranged for inward flow filtration

B01D 29/17—Open-ended {the arrival of the mixture to be filtered and the discharge of the concentrated mixture are situated on both opposite sides of the filtering element}

B01D 29/19—On solid frames with surface grooves or the like

B01D 29/21—With corrugated, folded or wound sheets

B01D 29/213—Having a concertina shape

B01D 29/216—With wound sheets

B01D 29/23—Arranged for outward flow filtration

B01D 29/232—With corrugated, folded or wound sheets

B01D 29/235—Having a concertina shape

B01D 29/237—With wound sheets

B01D 29/25—Open-ended {the arrival of the mixture to be filtered and the discharge of the concentrated mixture are situated on both opposite sides of the filtering element}

B01D 29/27—Filter bags

B01D 29/31—Self-supporting filtering elements

B01D 29/33—Arranged for inward flow filtration

B01D 29/333—With corrugated, folded filtering elements

B01D 29/336—Open-ended, the arrival of the mixture to be filtered and the discharge of the concentrated mixture are situated on both opposite sides of the filtering element

B01D 29/35—Arranged for outward flow filtration

B01D 29/353—With corrugated, folded filtering elements

B01D 29/356—Open-ended, the arrival of the mixture to be filtered and the discharge of the concentrated mixture are situated on both opposite sides of the filtering element

B01D 29/39—With hollow discs side by side on, or around, one or more tubes, e.g. of the leaf type

B01D 29/395—Mounted axially on the tube

B01D 29/41—Mounted transversely on the tube

B01D 29/413—Divided in sectors

B01D 29/416—Filtering tables

B01D 29/43—Mounted otherwise than transversely on the tube {mounted otherwise than axially on the tube

B01D 29/44—Edge filtering elements, i.e. using contiguous impervious surfaces

B01D 29/445—Bar screens

B01D 29/46—Of flat, stacked bodies

B01D 29/48—Of spirally or helically wound bodies

B01D 29/50—With multiple filtering elements, characterised by their mutual disposition (B01D 29/39 takes precedence)

B01D 29/52—In parallel connection

B01D 29/54—Arranged concentrically or coaxially

B01D 29/56—In series connection

B01D 29/58—Arranged concentrically or coaxially

B01D 29/60—Integrally combined with devices for controlling the filtration

B01D 29/601—By clearness or turbidity measuring

B01D 29/603—By flow measuring

B01D 29/605—By level measuring

B01D 29/606—By pressure measuring

B01D 29/608—By temperature measuring

B01D 29/62—Regenerating the filter material in the filter (devices for taking out of action one or more units of multi-unit filters, e.g. for regeneration, B01D 35/12)

B01D 29/64—By scrapers, brushes, {nozzles}, or the like, acting on the cake side of the filtering element

B01D 29/6407—Brushes

B01D 29/6415—With a rotary movement with respect to the filtering element

B01D 29/6423—With a translational movement with respect to the filtering element

B01D 29/643—With a combination of movements with respect to the filtering elements

B01D 29/6438—Nozzles

B01D 29/6446—With a rotary movement with respect to the filtering element

B01D 29/6453—With a translational movement with respect to the filtering element

B01D 29/6461—With a combination of movements with respect to the filtering elements

B01D 29/6469—Scrapers

B01D 29/6476—With a rotary movement with respect to the filtering element

B01D 29/6484—With a translatory movement with respect to the filtering element

B01D 29/6492—With a combination of movements with respect to the filtering elements

B01D 29/66—By flushing, e.g. counter-current air-bumps

B01D 29/661—By using gas-bumps

B01D 29/663—By using membranes

B01D 29/665—By using pistons

B01D 29/666—By a stirrer placed on the filtrate side of the filtering element

B01D 29/668—With valves, e.g. rotating valves for coaxially placed filtering elements

B01D 33/0003—Aspects of filters with filtering elements which move during the filtering operation

B01D 33/0006—With rotating filtering surfaces (rotating brush filters B01D 35/10)

B01D 33/0009—With cylindrical filtering surfaces, e.g. hollow drums, rotating drum filters for paper making D21B

B01D 33/0012—Drums provided with cells each independently connected with pressure distributor

B01D 33/0016—Drums with a single compartment

B01D 33/0019—Arranged for outward flow filtration

B01D 33/0022—Combined with filtering bands or the like

B01D 33/0025—With endless filtering bands

B01D 33/0029—With multiple filtering bands with or without one or more non filtering bands

B01D 33/0032—With loose, granular, or fibrous filtering material

B01D 33/0035—Gravity filters

B01D 33/0038—With external feed

B01D 33/0041—With plane surfaces

B01D 33/0045—With rotary tables

B01D 33/0048—With hollow discs transversely mounted on a hollow shaft

B01D 33/0051—With hollow frames axially mounted on a hollow shaft

B01D 33/0054—With loose, granular, or fibrous filtering material

B01D 33/0058—With filtering surfaces travelling along conveyors (tipping bucket type B01D 35/08; brush filters B01D 35/10)

B01D 33/0061—Accessories and components

B01D 33/0064—Devices for handling the filter cake, e.g. washing, discharging

B01D 33/0067—With scrapers, brushes, nozzles or the like placed on the cake-side of the filter (B01D 33/0074 takes precedence)

B01D 33/007—Counter-current flushing

B01D 33/0074—With backwash shoes, with nozzles

B01D 33/0077—By moving the filter element

B01D 33/008—By vibration

B01D 33/0083—By centrifugal force

B01D 33/0087—Feed or discharge devices for liquids

B01D 33/009—Pressure distribution systems (pressure distribution systems for filters with tipping buckets or trays B01D 35/08)

B01D 33/0093—Making filter elements (not provided for elsewhere) (see also B01D 24/001, B01D 25/001, B01D 27/005, B01D 29/012, B01D 29/111)

B01D 33/0096—Moving rectilinearly (filters B01D 35/10)

B01D 33/01—With translationally moving filtering elements, e.g. pistons (B01D 33/04-B01D 33/327 take precedence)

B01D 33/0108—With bag, cage, hose, tube, sleeve or the like filtering elements

B01D 33/0116—Arranged for inward flow filtration

B01D 33/0125—Open ended

B01D 33/0133—Arranged for outward flow filtration

B01D 33/0141—Open ended

B01D 33/015—With flat filtering elements

B01D 33/0158—Self-supporting

B01D 33/0166—Bar screens

B01D 33/0175—With curved filtering elements

B01D 33/0183—Supported

B01D 33/0191—With corrugated, folded or wound filtering sheets

B01D 33/03—With vibrating filter elements

B01D 33/0307—With bag, cage, hose, tube, sleeve or the like filtering elements

B01D 33/0315—Arranged for inward flow filtration

B01D 33/0323—Open ended

B01D 33/033—Arranged for outward flow filtration

B01D 33/0338—Open ended

B01D 33/0346—With flat filtering elements

B01D 33/0353—Self-supporting

B01D 33/0361—Bar screens

B01D 33/0369—With curved filtering elements

B01D 33/0376—Supported

B01D 33/0384—With corrugated, folded or wound filtering sheets

B01D 33/0392—With curved filtering elements

B01D 33/04—With filtering bands or the like supported on cylinders which are impervious for filtering

B01D 33/042—Whereby the filtration and squeezing-out take place between at least two filtering bands

B01D 33/044—With filtering bands or the like supported on cylinders which are pervious for filtering

B01D 33/048—With endless filtering bands

B01D 2033/052—Combined with a compression device

B01D 33/056—Construction of filtering bands or supporting belts, e.g. devices for centering, mounting or sealing the filtering bands or the supporting belts

B01D 33/0565—Combined with means to fasten the opposite edges of the filtering band together, e.g. Zipper

B01D 33/06—With rotary cylindrical filtering surfaces, e.g. hollow drums (B01D 33/044 takes precedence {; rotating drums for paper-making D21B})

B01D 33/067—Construction of the filtering drums, e.g. mounting or sealing arrangements

B01D 2033/07—Arranged for inward flow filtration

B01D 33/073—Arranged for inward flow filtration

B01D 33/09—With surface cells independently connected to pressure distributors

B01D 33/11—Arranged for outward flow filtration

B01D 33/13—With surface cells independently connected to pressure distributors

B01D 33/15—With rotary plane filtering surfaces

B01D 33/155—The filtering surface being parallel to the rotation axis

B01D 33/17—With rotary filtering tables (tables divided into separately tiltable buckets, trays or like sections B01D 33/327)

B01D 33/19—The table surface being divided in successively tilted sectors or cells, e.g. for discharging the filter cake

B01D 33/21—With hollow filtering discs transversely mounted on a hollow rotary shaft

B01D 33/215—The filtering discs being fixed inwardly on a rotating construction

B01D 33/23—Construction of discs or component sectors thereof

B01D 33/25—With hollow frames axially mounted on a hollow rotary shaft

B01D 33/27—With rotary filtering surfaces, which are neither cylindrical nor planar, e.g. helical surfaces

B01D 33/275—Using contiguous impervious surfaces

B01D 33/29—The movement of the filter elements being a combination of movements (B01D 33/19 takes precedence)

B01D 33/31—Planetary movement

B01D 33/327—Tipping buckets, trays or like sections

B01D 33/333—With individual filtering elements moving along a closed path (tipping buckets, trays or like sections B01D 33/327)

B01D 33/35—With multiple filtering elements characterised by their mutual disposition ({B01D 33/042 }, B01D 33/21 take precedence)

B01D 33/37—In parallel connection

B01D 33/39—Concentrically or coaxially

B01D 33/41—In series connection

B01D 33/42—Concentrically or coaxially

B01D 33/44—Regenerating the filter material in the filter (devices for taking out of action one or more units of multi-unit filters, e.g. for regeneration, B01D 35/12)

B01D 33/46—By scrapers, brushes {nozzles} or the like acting on the cake-side of the filtering element {(B01D 33/503 takes precedence)}

B01D 33/461—Brushes

B01D 33/463—Nozzles

B01D 33/465—Take-off rollers

B01D 33/466—Scrapers

B01D 33/468—Wires, strands, strings or the like

B01D 33/48—By flushing, e.g. counter-current air-bumps

B01D 36/001—Filters in combination with devices for the removal of gas, air purge systems}

B01D 36/003—Filters in combination with devices for the removal of liquids (B01D 35/185 takes precedence)

B01D 36/005—Liquid level sensing means, e.g. for water in gasoil-filters

B01D 36/006—Purge means

B01D 36/008—Means to filter or treat the separated liquid

B01D 36/02—Combinations of filters of different kinds (B01D 29/50, B01D 33/35 take precedence)

B01D 36/04—Combinations of filters with settling tanks

B01D 36/045—Combination of filters with centrifugal separation devices

B01D 37/041—By clearness or turbidity measuring

B01D 37/043—By flow measuring

B01D 37/045—By level measuring

B01D 37/046—By pressure measuring

B01D 37/048—By temperature measuring

B01D 39/00—Filtering material for liquid or gaseous fluids

B01D 39/02—Loose filtering material, e.g. loose fibres

B01D 39/04—Organic material, e.g. cellulose, cotton

B01D 39/06—Inorganic material, e.g. asbestos fibres, glass beads or fibres

B01D 39/08—Filter cloth, i.e. woven, knitted or interlaced material (metallic B01D 39/10)

B01D 39/083—Of organic material

B01D 39/086—Of inorganic material

B01D 39/10—Filter screens essentially made of metal

B01D 39/12—Of wire gauze; of knitted wire; of expanded metal

B01D 39/14—Other self-supporting filtering material {; Other filtering material (non-woven fabrics in general D04H 3/00)}

B01D 39/16—Of organic material, e.g. synthetic fibres

B01D 39/1607—The material being fibrous (B01D 39/18 takes precedence)

B01D 39/1615—Of natural origin

B01D 39/1623—Of synthetic origin

B01D 39/163—Sintered or bonded

B01D 39/1638—The material being particulate

B01D 39/1646—Of natural origin, e.g. cork or peat

B01D 39/1653 . . . {of synthetic origin}

B01D 39/1661—Sintered or bonded

B01D 39/1669—Cellular material

B01D 39/1676—Of synthetic origin

B01D 39/1684—Wound filtering material

### Provided by USPTO.gov.

### BACKGROUND OF INVENTION

Filtration of substances dates back before common era (Hippocrates is credited with the first filter material for water) and is one of the primary reasons modern societies enjoy clean water and fresh indoor air. Today most water is filtered by utilities or industries for distribution or usage and many of our homes use replaceable air filters in the air conditioners. Although the use of cannabis and cannabinoids pre-dates written history, usage in this manner has either not been recorded or has never occurred. Materials/mediums of similar nature are shown, for example, in the following United States of America patents:

U.S. Pat. No. 13,528,774 Howard
U.S. Pat. No. 9,718,004 Fujita
U.S. Pat. No. 9,750,829 Kozlov
U.S. Pat. No. 9,592,465 Disson
U.S. Pat. No. 9,149,748 Nagy
U.S. Pat. No. 9,005,342 Shimazaki
Though such filter materials/mediums have achieved considerable popularity and commercial success, there has been a continuing need for improvement.

### BRIEF SUMMARY OF INVENTION

This invention was created as a side-project of Michael D. Crippen's (the inventor) while receiving a BSBA in Marketing at the University of Central Florida, prior to pursuing a BS in Chemical Engineering from the University of South Florida. In an effort to discover and commercialize viable renewable and sustainable products, the inventor stumbled upon the idea for using industrial hemp as a filtration medium during conversation at a chamber of commerce meeting in East Orange County, Florida. The first piece of literature found validated that even trace amounts of non-intoxicating cannabinoids (commonly found throughout all parts of the cannabis plant) acted with as high as 99% anti-bacterial/-microbial efficacy. When used in combination with current filter mediums, designs and structures this invention presents a unique material opportunity to almost all industries and peoples. Not only is industrial hemp a renewable and sustainable cash crop, it is both cheaper and easier to work with then commonly used ultraviolet (constant input of electricity, bulky) and chlorine treatments (toxic, must be mitigated).

By initiating this patent we are promoting a new era of USA dominated manufacturing and seek to take back global economic status with regard to imports and exports. Currently the USA is the world's largest importer of industrial hemp products and materials, while China maintains as the world's largest exporter.

### INFORMATION DISCLOSURE STATEMENT

There are no prior domestic patents filed regarding the use of cannabis, cannabinoids or other cannabis compounds as filtration medium of any kind. The inventor has not sought patents in any other country, nor relates this patent application to any foreign or domestic patents or pending patent applications.

### DETAILED DESCRIPTION OF INVENTION

As pertaining to the embodiment of the invention, substance filtration/treatment materials and mediums are discussed below.

The most basic filter that can be comprised of industrial hemp, cannabis or cannabinoids is constructed by loosely inserting fibers inside a substance transfer device. An example of this would be a faucet aerator that has been modified to pass the water through one or more stages of industrial hemp, cannabis or cannabinoid material. The industrial hemp, cannabis or cannabinoids can also be used in powdered, crystalline or liquid form to assist in treatment of and decontamination of substances. An example of this would be the addition of pure liquid cannabinoids to treat other liquids like pools and prevent the accumulation of bacteria and/or microbes.

More complex filter materials can be produced by further processing the raw industrial hemp, cannabis or cannabinoids. An example of this is the filters made for a home air conditioning unit. Also chemically altering the industrial hemp, cannabis or cannabinoids will create unique characteristics. An example of this is the creation of a sponge material that can be used to reduce contaminants within a substance.

In addition to the use of industrial hemp, cannabis and cannabinoids independently, they can be used in combination and/or sequence with other filtration materials/mediums and treatment methods. An example of this would be a filter including both the claimed invention and activated carbon for enhanced performance. Non-filter treatments can also be used in conjunction with the industrial hemp, cannabis and cannabinoids. An example of this is following-up the chlorine/chloramine treatment done at municipal water treatment plants with a faucet filter.

With the introduction of a new method of providing anti-bacterial/-microbial properties to materials, integrating industrial hemp, cannabis or cannabinoids into substance transfer and/or containment systems presents a novel opportunity. An example of this would be produced piping that has cannabis fibers embedded within the components to treat substances as they pass through the pipe. Another example would be food packaging comprised of or containing industrial hemp, cannabis or cannabinoids in order to combat bacteria/microbes.

This invention includes those substances treated with the proprietary innovation intended for resale or distribution. An example of this would be a water bottling company that has been given a license to construct and utilize their own industrial hemp, cannabis and/or cannabinoid filtration/treatment.

Use of this invention to produce substances that improve processes or machinery comes into play as benefits of the new treatments/filtration materials become better understood. An example of this would be using or selling water filtered/treated with the invention for usage inside of a humidifier. Another example would be usage of the invention to clean waste water from hydraulic fracturing operations, improving the process by producing higher quality waste byproduct.

Substances treated with cannabinoids will be a large part of developing new industrial hemp, cannabis and/or cannabinoid filters/treatments. An example of this would be treating water with the invention and then filtering contaminated air through the water to capture both carbon and contaminants.

### REFERENCES

Nissen, L., Zatta, A., Stefanini, I., Grandi, S., Sgorbati, B., Biavati, B., & Monti, A. (n.d.), Characterization and antimicrobial activity of essential oils of industrial hemp varieties (Cannabis saliva L.). Retrieved Jul. 13, 2017, from http://www.sciencedirect.com/science/article/pll/S0367326X09002780

Khan, Belas Ahmed, Philip Warner, and Hao Wang. “Antibacterial properties of hemp and other natural fibre plants: a review.” BioResources 9.2 (2014): 3642-3659.

Khan, Belas Ahmed, et al. “Antibacterial properties of hemp hurd powder against E. coli.” Journal of Applied Polymer Science 132.10 (2015).

Hong-lin, L. A. I. “Primary research of hemp fiber features [J].” Shanghai Textile Science & Technology 3 (2004): 003

MARTINEC, Th, and M. Felklova. “Changes of the antibacterial activity in the course of the individual development of hemp (Cannabis sativa L.).” Die Pharmazie 14 (1959): 279.

What is claimed is:

1) Manufacturing and alterations of substance transfer, treatment or filtration devices and materials made with cannabis, industrial hemp or cannabinoids.

2) The materials and devices of claim 1, wherein the devices and materials are combined with other substance transfer, treatment or filtration devices and materials.

3) The materials and devices of claim 1, wherein the devices and materials are combined with non-filter water treatment methods.

4) The materials and devices of claim 1, wherein industrial hemp, cannabis, and/or cannabinoids are reformatted and/or integrated into substance transfer and/or containment systems.

5) The materials and devices of claim 1, wherein these devices and materials treat substances for sale or distribution.

6) The process of claim 5—treatment of substances with devices and materials made with industrial hemp, cannabis or cannabinoids—wherein the treated substances imbue or embed cannabinoids within a substance transfer system.

7) The process of claim 5—treatment of substances with devices and materials made with industrial hemp, cannabis or cannabinoids—wherein the treated substances improve processes or performance of machinery.

8) The process of claim 5—treatment of substances with devices and materials made with industrial hemp, cannabis or cannabinoids—wherein the treated substances result in the development of novel substance transfer, treatment and filtration processes, methods, materials or devices.
